(19) United States
(12) Patent Application Publication
(10) Pub. No.: US 2014/0350922 A1
(43) Pub. Date: Nov. 27, 2014

(54) SPEECH PROCESSING DEVICE, SPEECH PROCESSING METHOD AND COMPUTER PROGRAM PRODUCT

(71) Applicant: KABUSHIKI KAISHA TOSHIBA, Tokyo (JP)

(72) Inventors: Yamato Ohtani, Fuchu-shi (JP); Masahiro Morita, Yokohama-shi (JP)

(73) Assignee: KABUSHIKI KAISHA TOSHIBA, Tokyo (JP)

(21) Appl. No.: 14/194,976

(22) Filed: Mar. 3, 2014

(30) Foreign Application Priority Data
May 24, 2013 (JP) 2013-109897

(51) Int. Cl. G10L 25/18

(52) U.S. Cl. CPC G10L 25/18
USPC 704/205

(57) ABSTRACT

According to an embodiment, a speech processing device includes an extractor, a detector, a generator, a converter, and a compensator. The extractor is configured to extract a speech parameter from a spectral envelope of input speech. The detector is configured to detect a missing band in which a component is missed in the spectral envelope. The generator is configured to generate a parameter for the missing band on the basis of a position of the missing band, statistical information created by using a parameter extracted from a spectral envelope of speech with no missing component, and the extracted speech parameter. The converter is configured to convert the generated parameter to a spectral envelope of the missing band. The compensator is configured to generate a spectral envelope supplemented with the missing band by combining the spectral envelopes of the missing band and of the input speech.

### CROSS-REFERENCE TO RELATED APPLICATION

This application is based upon and claims the benefit of priority from Japanese Patent Application No. 2013-109897, filed on May 24, 2013; the entire contents of which are incorporated herein by reference.

### FIELD

An embodiment described herein relates generally to a speech processing device, a speech processing method, and a computer program product.

### BACKGROUND

In related art, bandwidth extension has been known as a technique for increasing the speech quality portable phones and voice recording devices. Bandwidth extension is a technique for creating a wideband speech from a narrowband speech and can, for example, compensate for high frequency speech components missing in input speech by using speech components that are not missing, for example.

The bandwidth extension of the related art, however, can compensate for speech components in a high frequency band missing in input speech or speech components in a predetermined specific frequency band, but cannot be applied to a case where some speech components in a certain frequency band are missing. A speech signal input to a speech processing device may have some speech components in a certain frequency band lost due to a certain effect such as static characteristics of a transmission channel, and it is desired to properly compensate for the speech components in the frequency band.

### BRIEF DESCRIPTION OF THE DRAWINGS

FIG. 1 is a block diagram illustrating a configuration of a speech processing device according to an embodiment;

FIG. 2 is a flowchart illustrating a flow of processing performed by the speech processing device according to the embodiment;

FIG. 3 is a graph illustrating an example of a method for detecting a missing band by a detector;

FIG. 4 is a graph illustrating an example of processing performed by a compensator; and

FIG. 5 is a graph illustrating another example of processing performed by the compensator.

### DETAILED DESCRIPTION

According to an embodiment, a speech processing device includes an extractor, a detector, a generator, a converter, and a compensator. The extractor is configured to extract a first speech parameter representing speech components in respective divided frequency bands from a first spectral envelope of input speech. The detector is configured to detect a missing band that is a frequency band in which a speech component is missed in the first spectral envelope. The generator is configured to generate a second speech parameter for the missing band, on the basis of a position of the detected missing band, statistical information created in advance by using a third speech parameter extracted from a second spectral envelope of another speech with no missing speech component, and the first speech parameter. The converter is configured to convert the second speech parameter to a third spectral envelope of the missing band. The compensator is configured to generate a fourth spectral envelope supplemented with the missing band by combining the first spectral envelope and the third spectral envelope.

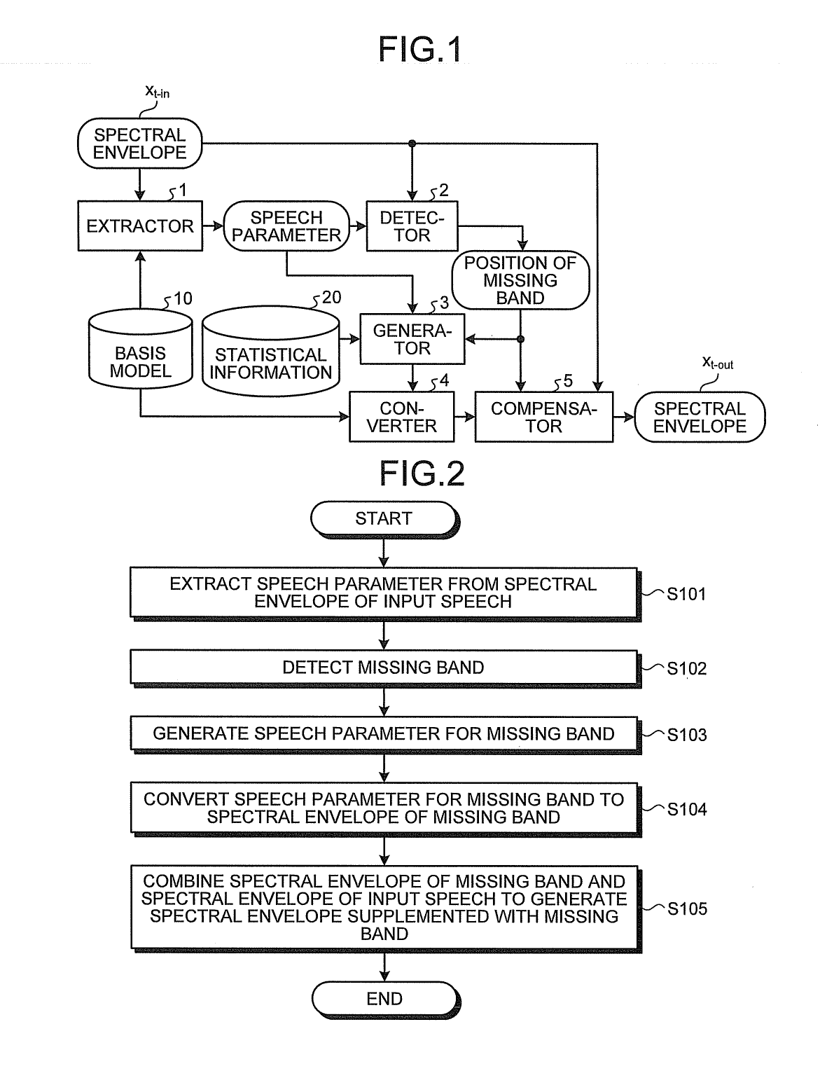

A speech processing device according to an embodiment generates a spectral envelope of speech supplemented with missing components from a spectral envelop of input speech in which speech components in a certain frequency band are missing. The input speech is mainly assumed to be speech uttered by a human. FIG. 1 is a block diagram illustrating a configuration of the speech processing device according to the embodiment. FIG. 2 is a flowchart illustrating a flow of processing performed by the speech processing device according to the embodiment.

As illustrated in FIG. 1, the speech processing device according to the embodiment includes an extractor 1, a detector 2, a generator 3, a converter 4, and a compensator 5.

The extractor 1 extracts a speech parameter of respective divided frequency bands from a spectral envelope χₜ_{_{—}}ᵢₙ of input speech by using a basis model 10 (step S101 in FIG. 2). Note that a process for generating the spectral envelope χₜ_{_{—}}ᵢₙ from the input speech may be performed inside or outside of the speech processing device.

The basis model 10 is a set of basis vectors representing bases of subspaces in a space formed by the spectral envelope χₜ of speech. In the embodiment, a sub-band basis spectrum model (hereinafter referred to as SEM) described in Reference 1 stated below is used as the basis model 10. The basis model 10 may be stored in advance in a storage unit, which is not illustrated, in the speech processing device or may be externally acquired and held during operation of the speech processing device.

Reference 1: M Tamura, T Kagoshima, and M Akamine, “Sub-band basis spectrum model for pitch-synchronous log-spectrum and phase based on approximation of sparse coding,” in Proceeding Interspeech 2010, pp. 2046-2049, September 2010.

According to Reference 1, bases according to the SBM have the following features (1) to (3):

(1) the bases have values ranging in a predetermined frequency band including a peak frequency with a single maximum value on the frequency axis, become zero outside of the frequency band, and do not have the same maximum values unlike periodical bases used in Fourier transform or cosine transform;
(2) the number of bases is smaller than the number of analysis points of a spectral envelope, and smaller than half the number of analysis points; and
(3) two bases having adjacent peak frequency positions overlap with each other, that is, the frequency ranges, in which the values range, of bases having adjacent peak frequencies partly overlap.

Furthermore, according to Reference 1, a basis vector representing a basis of the SBM is defined by the following Equation (1):

$${φ}_{n} ( k ) = \{ \begin{matrix}0.5 - 0.5 cos ( \frac{k - \tilde{Ω} ( n - 1 )}{\tilde{Ω} ( n ) - \tilde{Ω} ( n - 1 )} π ) & ( \tilde{Ω} ( n - 1 ) \leq k < \tilde{Ω} ( n ) ) \\ 0.5 - 0.5 cos ( \frac{k - \tilde{Ω} ( n )}{\tilde{Ω} ( n + 1 ) - \tilde{Ω} ( n )} π + \frac{π}{2} ) & ( \tilde{Ω} ( n ) \leq k < \tilde{Ω} ( n + 1 ) ) \\ 0 & ( otherwise )\end{matrix} \qquad ( 1 )$$

In the Equation, φₙ(k) represents a k-th component of an n-th basis vector. Furthermore, \tilde{Ω}(n) [rad] is a peak frequency of the n-th basis vector and defined as in the following Equation (2):

$$\tilde{Ω} ( n ) = \{ \begin{matrix}Ω + 2 {tan}^{- 1} \frac{α sin Ω}{1 - α cos Ω} & ( 0 \leq n < {N}_{w} ) \\ \frac{n - {N}_{w}}{N - {N}_{w}} π + \frac{π}{2} & ( {N}_{w} \leq n < N )\end{matrix} \qquad ( 2 )$$

In Equation (2), α represents an expansion/compression factor, Ω represents a frequency [rad], and N_{w} is a value satisfying \tilde{Ω}(N_{w})=π/2.

Furthermore, in the SEM, the spectral envelope χₜ=[χₜ(1), χₜ(2), . . . , χₜ(k), . . . , χₜ(K)]^{T} of a t-th frame is expressed by the following Equation (3) by weighted linear combination of bases having the aforementioned features:

$${χ}_{t} = exp ( \frac{1}{2} φ {C}_{t} ) \qquad ( 3 )$$

In the Equation, cₜ=[cₜ(0), cₜ(1), . . . , cₜ(n), . . . , cₜ(N−1)]^{T} is a weight vector of the t-th frame on a basis vector in the SBM, and φ=[φ₀, φ₁, . . . , φₙ, . . . , φ_{N-1}] represents a matrix into which the basis vector is converted.

In the embodiment, weight vectors ct associated with the respective basis vectors in the SEM are used as a speech parameter. The speech parameter can be extracted from the spectral envelope χₜ by using a non-negative least squared error solution described in Reference 1. Specifically, the weight vectors ct that are a speech parameter are obtained by optimization so that an error between a linear combination of the basis vectors and the weight vectors ct and the spectral envelope χₜ is minimum under a restriction that the value of the speech parameter is always not smaller than zero.

In the embodiment, the number of analysis points used for analysis of the spectral envelope χₜ is assumed to be 160 or greater, and the number of bases in the SBM is thus 80. Among the bases, the first to 55th bases representing low frequency bands of 0 to π/2 radians on the frequency axis are generated according to the mel scale based on the expansion/compression factor (0.35 herein) of an all-pass filter used for mel-cepstral analysis. In addition, the 56th to 80th bases representing high frequency bands of π/2 radians or higher on the frequency axis are those generated according to the linear scale. Alternatively, the bases of the low frequency bands may be those generated by using a scale other than the mel scale such as the linear scale, the Bark scale, or the ERB scale.

Note that the SBM is used as the basis model 10 for extracting a speech parameter from the spectral envelope χₜ in the embodiment. However, any basis model 10 capable of extracting a speech parameter representing speech components of respective divided local frequency bands from the spectral envelope χₜ and reproducing the original spectral envelope χₜ from the extracted speech parameters may be used. For example, a basis model obtained according to a sparse coding method or a basis matrix obtained by non-negative matrix factorization can be used as the basis model 10 for extracting a speech parameter from the spectral envelope χₜ. Furthermore, a representation by sub-band division or a filter bank may be used to extract a speech parameter of respective divided local frequency bands can be extracted from the spectral envelope χₜ and the original spectral envelope χₜ can be reproduced from the extracted speech parameters.

The detector 2 analyzes the spectral envelope χₜ_{_{—}}in of the input speech or the shape of the envelope of speech parameters extracted by the extractor 1 from the spectral envelope χₜ_{_{—}}in to detect a missing band that is a frequency band in which speech components are missing in the spectral envelope χₜ_{_{—}}in of the input speech (step S102 in FIG. 2).

The detector 2 can detect the missing band by using a first-order change rate and a second-order change rate in the frequency axis direction from the spectral envelope χₜ_{_{—}}in of the input speech or the speech parameters extracted from the spectral envelope χₜ_{_{—}}in.

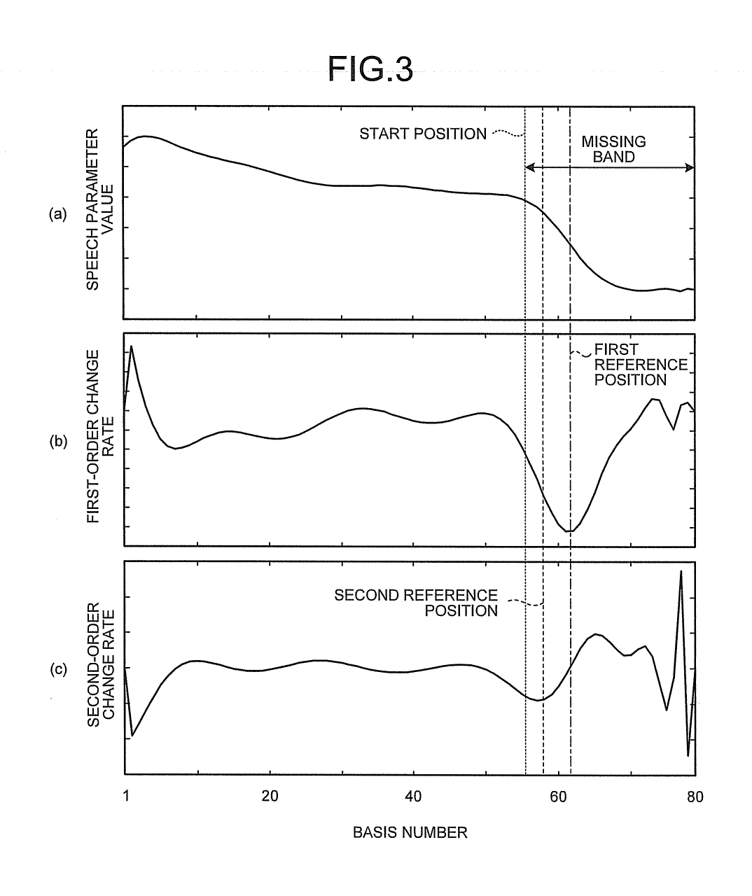

FIG. 3 is a graph illustrating an example of the method for detecting a missing band by the detector 2. The example illustrated in FIG. 3 is an example in which high frequency components are missing as a result of the input speech passing through a transmission channel having low-pass characteristics and in which the missing band is detected by analyzing the shape of the envelope of speech parameters extracted from the spectral envelope χₜ_{_{—}}in. The horizontal axis in FIG. 3 represents the frequency axis and the numerals represent the basis numbers. In FIG. 3, (a) is a graph illustrating the variation in the frequency axis direction of the speech parameter extracted from the spectral envelope χₜ_{_{—}}in of the input speech by the extractor 1, and the vertical axis thereof represents the value of the speech parameter. In FIG. 3, (b) is a graph illustrating the first-order change rate in the frequency axis direction of the speech parameter illustrated in (a) of FIG. 3, and the vertical axis thereof represents a first-order differential of the speech parameter. In FIG. 3, (c) is a graph illustrating the second-order change rate in the frequency axis direction of the speech parameter illustrated in (a) of FIG. 3, and the vertical axis thereof represents a second-order differential of the speech parameter.

The detector 2 first searches for and determines a dimension (hereinafter referred to as a first reference position) with the smallest value from the first change rate of the speech parameter illustrated in (b) of FIG. 3 in descending order of the dimension. Subsequently, the detector 2 obtains a dimension (hereinafter referred to as a second reference position) with the smallest value within a search, range from the second-order change rate of the speech parameter illustrated in (c) of FIG. 3, the search range being a range between the first reference position and a dimension that is lower than the first reference position by several dimensions. The detector 2 then determines the position lower than the second reference point by one dimension to be a start position that is an end on the low frequency side of the missing band. Furthermore, since a case where high-frequency components are missing is assumed in the example illustrated in FIG. 3, an end position that is an end on the high frequency side of the missing band is the position with the highest dimension. The detector 2 can detect the frequency band between the start position and the end position determined as described above as the missing band.

When low-frequency components are missing as a result of the input speech passing through a transmission channel having high-pass characteristics, the missing band can be detected by performing processing similar to the above in ascending order of the dimension. Specifically, the detector 2 first searches for a dimension from the first-order change rate of the speech parameter in ascending order of the dimension to determine the first reference position. Subsequently, the detector 2 obtains the second reference position from the second-order change rate of the speech parameter within a search range being a range between the first reference position and a dimension that is higher than the first reference position by several dimensions. The detector 2 then determines the position higher than the second reference position by one dimension to be an end position that is an end on the high frequency side of the missing band. In this case, the start position that is an end on the low frequency side of the missing band is the position with the lowest dimension. The detector 2 can detect the frequency band between the start position and the end position determined as described above as the missing band.

When components in a certain frequency band between the low frequency band and the high frequency band are missing as a result of the input speech passing through a transmission channel having band stop characteristics, the detector 2 can detects the missing band by the following method, for example. The detector 2 first obtains the first-order change rate and the second-order change rate from lower dimension of the speech parameter from which spectral tilt information is removed, and obtains dimensions where the first-order change rate is the highest and the lowest, and determines these dimensions to be first reference positions. Subsequently, the detector 2 obtains a point where the second-order change rate is the lowest at a lower dimension than the first reference position where the first-order change rate is the lowest. Similarly, the detector 2 obtains a point where the change rate is the lowest at a higher dimension than the first reference position where the first-order change rate is the highest, and determines these points to be second reference positions. The detector 2 then defines the one at the lower dimension of these two second reference positions as the start position and the one at the higher dimension as the end position. The detector 2 can detect the frequency band between the start position and the end position defined as described above as the missing band.

When a missing band is caused due to the characteristics of the transmission channel of the input speech, the missing band is assumed to be constant for each input speech. Thus, the detector 2 can detect the missing band by performing the above-described processing on at least one frame of the input speech. The detector 2, however, can more accurately detect the missing band by performing the above-described processing on multiple frames of the input speech. In this case, the detector 2 can accurately detect a missing position by obtaining an average of the speech parameters of multiple frames for each dimension and using the first-order change rate and the second-order change rate of the obtained average. Alternatively, the detector 2 may perform the above-described processing on the speech parameter of each of multiple frames and merge the obtained results to detect an ultimate missing band.

Alternatively, the detector 2 may repeat the above-described processing on each frame of the input speech, so that different missing points between frames can be detected even when the missing band in the input speech is different between frames due to a sudden factor.

While the above-described processing is performed on the speech parameter extracted from the spectral envelope χₜ_{_{—}}in of the input speech, the missing band can be detected by similar processing performed on the spectral envelope χₜ_{_{—}}in itself of the input speech. Thus, the missing band can also be detected by performing similar processing to the above on the spectral envelope χₜ_{_{—}}in of the input speech by using the first-order change rate and the second-order change rate in the frequency axis direction.

The generator 3 generates the speech parameter for the missing band on the basis of the position of the missing band detected by the detector 2, statistical information 20, and the speech parameter extracted from the spectral envelope χₜ_{_{—}}in of the input speech by the extractor 1 (step S103 in FIG. 2).

The statistical information 20 is created in advance by using the speech parameter extracted from the spectral envelope of speech with no missing speech components (the speech parameter similar to that extracted from the spectral envelope χt_in of the input speech by the extractor 1). Note that statistical information is a model of the speech parameter obtained by averages, variances, and a histogram of speech parameter vectors, such as a code book, a mixture model, or a hidden Markov model in the embodiment, a Gaussian mixture model (hereinafter referred to as GMM) is used as the statistical information 20. The statistical information 20 may be stored in advance in a storage unit, which is not illustrated, in the speech processing device or may be externally acquired and held during operation of the speech processing device.

In the GMM, the probability density function of the weight vector ct is expressed as in the following Equation (4):

$$P ( {c}_{t} \vert λ ) = {\sum }_{m = 1}^{M} P ( {c}_{t} \vert m , λ ) = {\sum }_{m = 1}^{M} {α}_{m} N ( {c}_{t} ; {μ}_{m}^{( c )} , {\sum }_{m}^{( cc )} ) \qquad ( 4 )$$

In Equation (4), λ represents a parameter set of the GMM, N(cₜ; μₘ^{(c)}, Σₘ^{(cc)}) represents an m-th normal distribution of the GMM having an average vector μₘ^{(c)} and a full covariance matrix Σₘ^{(cc)}, and αₘ represents the weight on the m-th normal distribution.

In the embodiment, it is assumed that the number of parameter components (hereinafter referred to as remaining band components) for the remaining band (band other than the missing band) and the number of parameter components (hereinafter referred to as missing band components) for the missing band are different. Thus, a full covariance matrix, that is, a matrix with all elements having certain values is used. In an embodiment in which the number of the remaining band components and the number of the missing band components are always the same, however, a variance matrix with diagonal elements, predetermined remaining band components, and missing band components associated therewith having values and the other elements being zero may be used instead of the full covariance matrix.

In the embodiment, an unspecified speaker GMM that is a statistical model built in advance by using the speech parameter extracted from speech uttered by multiple speakers with no missing speech components (no missing band) as learned data is used as the statistical information 20. The statistical information 20 can be built by using an LGB algorithm or an EM algorithm, for example.

The generator 3 obtains a rule for generating the missing band components from the remaining band components by using the GMM as the statistical information 20 by the following procedures.

The generator 3 first converts the GMM that is the statistical information 20 as expressed by the following Equation (5) by dividing speech parameter vectors, an average vector μₘ^{(c)}, and a covariance matrix Σₘ^{(cc)} on the basis of the position of the missing band detected by the detector 2, that is, the aforementioned start position and end position:

$$P ( {c}_{t} \vert λ ) = {\sum }_{m = 1}^{M} {α}_{m} N ( [ \begin{matrix}{c}_{t}^{( r )} \\ {c}_{t}^{( l )}\end{matrix} ] ; [ \begin{matrix}{μ}_{m}^{( r )} \\ {μ}_{m}^{( l )}\end{matrix} ] , [ \begin{matrix}{\sum }_{m}^{( rr )} & {\sum }_{m}^{( rl )} \\ {\sum }_{m}^{( lr )} & {\sum }_{m}^{( ll )}\end{matrix} ] ) \qquad ( 5 )$$

In Equation (5), cₜ^{(r)} represents a speech parameter vector of the remaining band, cₜ^{(l)} represents a speech parameter vector of the missing band, μₘ^{(r)} represents an average vector of the remaining band, μₘ^{(l)} represents an average vector of the missing band, Σₘ^{(rr)} represents a self-covariance matrix of the remaining band, Σₘ^{(ll)} represents a self-covariance matrix of the missing band, and Σₘ^{(lr)} represents a cross-covariance matrix of the missing band and the remaining band.

Subsequently, the generator 3 converts the converted GMM into a conditional probability distribution of the speech parameter vectors of the missing band with respect to the speech parameter vectors of the remaining band as expressed by the following Equation (6). The generator 3 then uses the conditional probability distribution expressed by Equation (6) as a rule to generate the missing band components (the speech parameter for the missing band) from the remaining band components (the speech parameter extracted from the spectral envelope χt_in of the input speech).

$$\begin{matrix}P ( {c}_{t}^{( l )} \vert {c}_{t}^{( r )} , λ ) = {\sum }_{m = 1}^{M} P ( m \vert {c}_{t}^{( r )} , λ ) P ( {c}_{t}^{( l )} \vert {c}_{t}^{( r )} , m , λ ) & ( 6 ) \\ In Equation ( 6 ) , & \\ P ( m \vert {c}_{t}^{( r )} , λ ) = \frac{{α}_{m} N ( {c}_{t}^{( r )} ; {μ}_{m}^{( r )} , {\sum }_{m}^{( rr )} )}{{\sum }_{m = 1}^{M} {α}_{m} N ( {c}_{t}^{( r )} ; {μ}_{m}^{( r )} , {\sum }_{m}^{( rr )} )} & ( 7 ) \\ P ( {c}_{t}^{( l )} \vert {c}_{t}^{( r )} , m , λ ) = N ( {c}_{t}^{( l )} , {E}_{m , t}^{( l )} , {D}_{m}^{( ll )} ) & ( 8 ) \\ {E}_{m , t}^{( l )} = {\sum }_{m}^{( lr )} {\sum }_{m}^{{( rr )}^{- 1}} ( {c}_{t}^{( r )} - {μ}_{m}^{( r )} ) + {μ}_{m}^{( l )} & ( 9 ) \\ {D}_{m}^{( l )} = {\sum }_{m}^{( ll )} - {\sum }_{m}^{( lr )} {\sum }_{m}^{{( rr )}^{- 1}} {\sum }_{m}^{( rl )} & ( 10 )\end{matrix}$$

As a result, the speech parameter \tilde{c}ₜ^{(l)} of the missing band is obtained as in the following Equation (11) by the least squared error criterion:

$${\tilde{c}}_{t}^{( l )} = {\sum }_{m = 1}^{M} P ( m \vert {c}_{t}^{( r )} , λ ) {E}_{m , t}^{( l )} \qquad ( 11 )$$

In the embodiment, the missing band in one input speech is assumed to be constant among frames as described above. In this case, frames will be discontinuous if a speech parameter for the missing band is generated for each frame. To reduce the discontinuity, the generator 3 may perform smoothing by a moving average filter, a median filter, a weighted average filter, a Gaussian filter or the like by using a subject frame and several frames before and after the subject frames so that the discontinuity of the speech parameter for the missing band among frames will be reduced.

Furthermore, the speech parameter for the missing band generated by the generator 3 is smoothed due to the influence of the generalized GMM. Thus, the generator 3 may perform parameter enhancement by using statistical information of the global variance (hereinafter referred to as GV) mentioned in the following Reference 2 or the histogram of the speech parameter after generating the speech parameter for the missing band.

Reference 2: Wataru FUJITSURU, et al., “Bandwidth Extension of Cellular Phone Speech based on Maximum Likelihood Estimation with GMM”, IPSJ SIG Technical Report, Jul. 21, 2007, pp. 63-68.

To prevent the discontinuity among frames and smoothing of the speech parameter, the generator 3 may further generate the speech parameter for the missing band by using the GMM estimation with the maximum likelihood criterion using dynamic features described in Reference 2. In this case, features Ct expressed by the following Equation (12) combining a weight vector ct that is the speech parameter and a time-varying component Δct of the weight vector ct is provided in learning of the GMM, the GMM expressed by the following Equation (13) is built, and the built GMM is held as the statistical information 20:

$$\begin{matrix}{C}_{t} = {[ {c}_{t}^{Γ} , Δ {c}_{t}^{Γ} ]}^{Γ} & ( 12 ) \\ P ( {C}_{t} \vert λ ) = {\sum }_{m = 1}^{M} P ( {C}_{t} \vert m , λ ) = {\sum }_{m = 1}^{M} {α}_{m} N ( {C}_{t} ; {μ}_{m}^{( c )} , {\sum }_{m}^{( cc )} ) & ( 13 )\end{matrix}$$

In Equation (13), μₘ^{(c)} represents an average vector of the combined features held in m-th distribution, and Σₘ^{(cc)} is a full covariance matrix of the combined features held by the m-th distribution.

When the GMM expressed by Equation (13) is used as the statistical information 20, the generator 3 also first divides the GMM into the remaining band components and the missing band components on the basis of the position (start position and end position) of the missing band detected by the detector 2, and converts Equation (13) into the following Equation (14):

$$P ( {C}_{t} \vert λ ) = {\sum }_{m = 1}^{M} {α}_{m} N ( [ \begin{matrix}{C}_{t}^{( R )} \\ {C}_{t}^{( L )}\end{matrix} ] ; [ \begin{matrix}{μ}_{m}^{( R )} \\ {μ}_{m}^{( L )}\end{matrix} ] , [ \begin{matrix}{\sum }_{m}^{( RR )} & {\sum }_{m}^{( RL )} \\ {\sum }_{m}^{( LR )} & {\sum }_{m}^{( LL )}\end{matrix} ] ) \qquad ( 14 )$$

Subsequently, the generator 3 converts the GMM expressed by Equation (14) into a conditional probability distribution of the speech parameter vectors of the missing band with respect to the speech parameter vectors of the remaining band as expressed by the following Equation (15):

$$P ( {C}_{t}^{( L )} \vert {C}_{t}^{( R )} , λ ) = {\sum }_{m = 1}^{M} P ( m \vert {C}_{t}^{( R )} , λ ) P ( {C}_{t}^{( R )} \vert {C}_{t}^{( R )} , m , λ ) \qquad ( 15 )$$

The generator 3 then generates the speech parameter for the missing band as expressed by the following Equations (16) and (17) on the basis of the maximum likelihood criterion:

$$\begin{matrix}{[ {\tilde{c}}_{1}^{{( l )}^{Γ}} , {\tilde{c}}_{2}^{{( l )}^{Γ}} , … {\tilde{c}}_{T}^{{( l )}^{Γ}} ]}^{Γ} = arg {max}_{{c}^{( l )}} {∐}_{t}^{T} {\sum }_{m = 1}^{M} P ( m \vert {C}_{t}^{( R )} , λ ) P ( {C}_{t}^{( L )} , {C}_{t}^{( R )} , m , λ ) & ( 16 ) \\ Subject to & \\ {[ {C}_{1}^{{( L )}^{Γ}} , {C}_{2}^{{( L )}^{Γ}} , … {C}_{T}^{{( L )}^{Γ}} ]}^{Γ} = {W [ {c}_{1}^{{( l )}^{Γ}} , {c}_{2}^{{( l )}^{Γ}} , … {c}_{T}^{{( l )}^{Γ}} ]}^{Γ} & ( 17 )\end{matrix}$$

In the equations, W represents a matrix for converting the speech parameters to the combined features each combining the speech parameter and the time-varying component.

Alternatively, the generator 3 may generate the speech parameter for the missing band from near maximum likelihood distributions or by the parameter generation method using the GV described in Reference 2 in place of Equation (16) or may perform parameter enhancement using the GV or a histogram after generating the speech parameter by Equation (16).

Note that it is assumed in the embodiment that the unspecified speaker GMM is used as the statistical information 20). However, in addition to the unspecified speaker GMM, multiple specified speaker GMMs may be used as the statistical information 20. In this case, the generator 3 generates the speech parameter for the missing band by using a specified speaker GMM that most fits the speech parameter extracted from the spectral envelope χₜ_{_{—}}ᵢₙ of the input speech or a linear combination of multiple specified speaker GMMs according to the goodness of fit. As a result, the speech parameter of the missing band can be generated to fit the speech parameter extracted from the spectral envelope χₜ_{_{—}}ᵢₙ of the input speech.

Furthermore, to improve the fitness to the speech parameter extracted from the spectral envelope χₜ_{_{—}}ᵢₙ of the input speech, the speech parameter for the missing band may be generated by applying a speaker adaptation technique such as linear regression and maximum a posteriori estimation used in statistical speech recognition and speech synthesis to the unspecified speaker GMM or specified speaker GMMs and by using the GMM that fits the speech parameter extracted from the spectral envelope χₜ_{_{—}}ᵢₙ of the input speech.

The converter 4 converts the speech parameter for the missing band generated by the generator 3 to a spectral envelope of the missing band by using the basis model 10 (step S104 in FIG. 2).

In the embodiment, since the SBM is used as the basis model 10, the weight vector ct generated as the speech parameter for the missing band can be converted to the speech spectral envelope \tilde{χ}ₜ of the missing band by performing processing as expressed by Equation (3) above. Specifically, the converter 4 can obtain the spectral envelope \tilde{χ}ₜ of the missing band by linearly combining the weight vector ct that is the speech parameter for the missing band and the basis vector for the missing band.

The compensator 5 combines the spectral envelope \tilde{χ}ₜ of the missing band obtained by the converter 4 and the spectral envelope χₜ_{_{—}}ᵢₙ of the input speech to generate a spectral envelope χₜ_{_{—}}ₒᵤₜ supplemented with the missing band (step S105 in FIG. 2).

The compensator 5 can generate the spectral envelope χₜ_{_{—}}ₒᵤₜ supplemented with the missing band by applying the spectral envelope \tilde{χ}ₜ of the missing band obtained by the converter 4 to the position of the missing band (the band between the start position and the end position) detected by the detector 2 in the spectral envelope χₜ_{_{—}}ᵢₙ of the input speech and performing a process to reduce the discontinuity to combine the spectral envelopes.

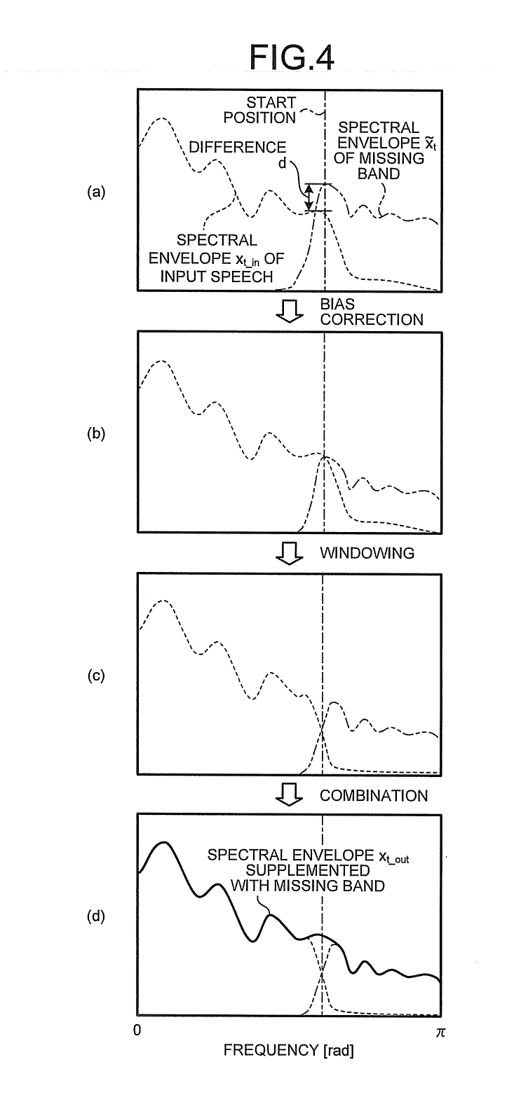

FIG. 4 is a graph illustrating an example of the processing performed by the compensator 5. The example illustrated in FIG. 4 is an example of generating the spectral envelope χₜ_{_{—}}ₒᵤₜ supplemented with the missing band from the spectral envelope χₜ_{_{—}}ᵢₙ of the input speech in which high frequency components are missing due to a transmission channel having low-pass characteristics.

If the spectral envelope \tilde{χ}ₜ of the missing band obtained by the converter 4 is applied as it is to the position of the missing band in the spectral envelope χₜ_{_{—}}ᵢₙ of the input speech, the values of the two spectral envelopes may differ from each other at the boundaries of the missing and discontinuity may occur. Thus, the compensator 5 first measures a difference d between the two spectral envelopes at a boundary position of the missing band ((a) of FIG. 4). The compensator 5 then performs bias correction on the entire spectral envelope \tilde{χ}ₜ of the missing band obtained by the converter 4 on the basis of the measured difference d ((b) of FIG. 4).

Subsequently, the compensator 5 windows components around the boundary position between the spectral envelope χₜ_{_{—}}ᵢₙ of the input speech and the spectral envelope \tilde{χ}ₜ of the missing band by using a one-sided harm window ((c) of FIG. 4) so that the spectral envelopes are smoothly connected, and adds the components of the spectral envelopes at the position to combine the spectral envelope χₜ_{_{—}}ᵢₙ of the input speech and the spectral envelope \tilde{χ}ₜ of the missing band ((d) of FIG. 4). As a result, the spectral envelope χₜ_{_{—}}ₒᵤₜ supplemented with the missing band is generated.

Note that, for generating the spectral envelope χₜ_{_{—}}ₒᵤₜ supplemented with the missing band from the spectral envelope χₜ_{_{—}}ᵢₙ of the input speech in which low frequency components are missing due to a transmission channel having high-pass characteristics, the spectral envelope χₜ_{_{—}}ₒᵤₜ supplemented with the missing band can be properly generated by procedures similar to the above.

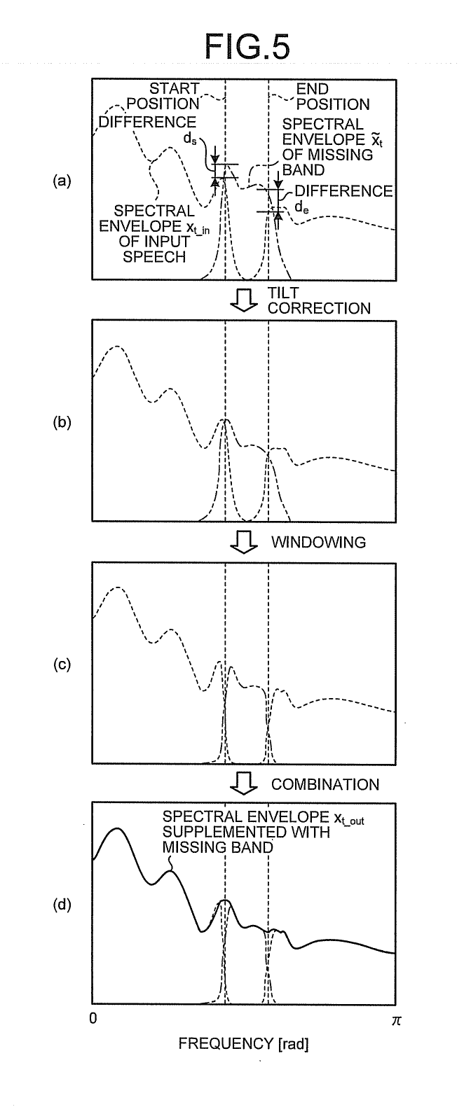

FIG. 5 is a graph illustrating another example of the processing performed by the compensator 5. The example illustrated in FIG. 5 is an example of generating the spectral envelope χₜ_{_{—}}ₒᵤₜ supplemented with the missing band from the spectral envelope χₜ_{_{—}}ᵢₙ of the input speech in which components in a certain frequency band between the low frequency band and the high frequency band are missing due to a transmission channel having band stop characteristics.

In the example of FIG. 5, the compensator 5 measures a difference ds between the two spectral envelopes at the start position, of the missing band and a difference de between the two spectral envelopes at the end position of the missing band ((a) of FIG. 5). The compensator 5 then performs tilt correction on the spectral envelope \tilde{χ}ₜ of the missing band obtained by the converter 4 on the basis of the difference ds measured at the start position of the missing band and the difference de measured at the end position of the missing band ((b) of FIG. 5).

Subsequently, the compensator 5 windows components around the start position and the end position by using a one-sided hann window ((c) of FIG. 5) so that the spectral envelope χₜ_{_{—}}ᵢₙ of the input speech and the spectral envelope \tilde{χ}ₜ of the missing band are smoothly connected both at the start position and at the end position, and adds the components of the spectral envelopes at the position to combine the spectral envelope χₜ_{_{—}}ᵢₙ of the input speech and the spectral envelope \tilde{χ}ₜ of the missing band ((d) of FIG. 5). As a result, the spectral envelope χₜ_{_{—}}ₒᵤₜ supplemented with the missing band is generated.

The speech processing device according to the embodiment can output the spectral envelope χₜ_{_{—}}ₒᵤₜ supplemented with the missing band generated by the compensator 5 to outside. In addition, the speech processing device according to the embodiment may be configured to restore speech from the spectral envelope χₜ_{_{—}}ₒᵤₜ supplemented with the missing band and output the restored speech.

As described in detail above with reference to specific examples, speech components missing in a certain frequency band can be properly compensated for according to the speech processing device of the embodiment.

The speech processing device of the embodiment can be realized by using a general-purpose computer system as basic hardware, for example. Specifically, the speech processing device of the embodiment can be realized by causing a processor installed in the general-purpose computer system to execute programs. The speech processing device may be realized by installing the programs in the computer system in advance, or may be realized by storing the programs in a storage medium such as a CD-ROM or distributing the programs via a network and installing the programs in the computer system where necessary. Alternatively, the speech processing device may be realized by executing the programs on a server computer system and receiving the result by a client computer system via a network.

Furthermore, information to be used by the speech processing device of the embodiment can be stored using memory included in the computer system or an external memory, a hard disk or a storage medium such as a CD-R, a CD-RW, a DVD-RAM, and a DVD-R. For example, the basis model 10 and the statistical information 20 to be used by the speech processing device of the embodiment can be stored by using these recording media as appropriate.

The programs to be executed by the speech processing device of the embodiment have a modular structure including the respective processing units (the extractor 1, the detector 2, the generator 3, the converter 4, and the compensator 5) included in the speech processing device. In an actual hardware configuration, a processor reads the programs from the storage medium as mentioned above, provided as a computer program product, and executes the programs, whereby the respective processing units are loaded on a main storage device and generated thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech processing device, comprising:
an extractor configured to extract a first speech parameter representing speech components in respective divided frequency bands from a first spectral envelope of input speech;
a detector configured to detect a missing band that is a frequency band in which a speech component is missed in the first spectral envelope;
a generator configured to generate a second speech parameter for the missing band, on the basis of a position of the missing band, statistical information created in advance by using a third speech parameter extracted from a second spectral envelope of another speech with no missing speech component, and the first speech parameter;
a converter configured to convert the second speech parameter to a third spectral envelope of the missing band; and
a compensator configured to generate a fourth spectral envelope supplemented with the missing band by combining the first spectral envelope and the third spectral envelope.

2. The device according to claim 1, wherein
the first speech parameter is a value calculated by using multiple basis vectors respectively associated with the divided frequency bands, and
the number of basis vectors is smaller than the number of analysis points used for analysis of the first spectral envelope.

3. The device according to claim 2, wherein ranges of the frequency bands associated with the basis vectors that are adjacent to each other on a frequency axis partly overlap with each other.

4. The device according to claim 2, wherein the first speech parameter is weight vectors determined so that an error between a linear combination of the basis vectors and the weight vectors associated with the respective basis vectors and the first spectral envelope is minimum.

5. The device according to claim 1, wherein the detector is configured to analyze the first spectral envelope or an envelope shape of the first speech parameter to detect the missing band.

6. The device according to claim 1, wherein the statistical information is a statistical model built using speech parameters extracted from speeches of multiple speakers with no missing speech components as learned data.

7. The device according to claim 1, wherein the statistical information is a statistical model built using speech parameters extracted from speeches of multiple speakers with no missing speech components and time-varying components extracted from the speech parameters as learned data.

8. The device according to claim 1, wherein the generator is configured to build a rule for generating the second speech parameter from a fourth speech parameter for a remaining band that is a frequency band excluding the missing band on the basis of the position of the missing band and the statistical information, and generate the second speech parameter from the first speech parameter by using the rule.

9. The device according to claim 4, wherein the converter is configured to convert the second speech parameter to the third spectral envelope of the missing band by linear combination of the weight vectors generated as the second speech parameter and the basis vectors associated with the missing band.

10. The device according to claim 1, wherein the position of the missing band is determined on the basis of a frequency band between a start position that is an end on a low frequency side of the missing band and an end position that is an end on a high frequency side of the missing band.

11. A speech processing method, comprising:
extracting a first speech parameter representing speech components in respective divided frequency bands from a first spectral envelope of input speech;
detecting a missing band that is a frequency band in which a speech component is missed in the first spectral envelope;
generating a second speech parameter for the missing band, on the basis of a position of the missing band, statistical information created in advance by using a third speech parameter extracted from a second spectral envelope of another speech with no missing speech component, and the first speech parameter;
converting the second speech parameter to a third spectral envelope of the missing band; and
generating a fourth spectral envelope supplemented with the missing band by combining the first spectral envelope and the third spectral envelope.

12. A computer program product comprising a computer-readable medium containing a program executed by a computer, the program causing the computer to execute:
extracting a first speech parameter representing speech components in respective divided frequency bands from a first spectral envelope of input speech;
detecting a missing band that is a frequency band in which a speech component is missed in the first spectral envelope;
generating a second speech parameter for the missing band, on the basis of a position of the missing band, statistical information created in advance by using a third speech parameter extracted from a second spectral envelope of another speech with no missing speech component, and the first speech parameter;
converting the second speech parameter to a third spectral envelope of the missing band; and
generating a fourth spectral envelope supplemented with the missing band by combining the first spectral envelope and the third spectral envelope.
